(19) United States
(12) Patent Application Publication
(10) Pub. No.: US 2025/0306585 A1
(43) Pub. Date: Oct. 2, 2025

(54) WORKING SYSTEM

(71) Applicant: HONDA MOTOR CO., LTD., TOKYO (JP)

(72) Inventors: Jun YOSHIKAWA, WAKO-SHI (JP); Lei YUAN, TOKYO (JP)

(21) Appl. No.: 19/066,588

(22) Filed: Feb. 28, 2025

(30) Foreign Application Priority Data
Mar. 29, 2024 (JP) 2024-055987

(51) Int. Cl. G05D 1/224; G05D 1/227; G05D 105/50; G05D 107/20; G05D 109/10; G05D 111/10

(52) U.S. Cl. CPC G05D 1/2245; G05D 1/2279; G05D 2105/50; G05D 2107/20; G05D 2109/10; G05D 2111/10

(57) ABSTRACT

A working system that is capable of carrying out a work by working equipment that is operated remotely, the working system including an image generating unit that generates a virtual space image corresponding to an actual space surrounding a working movable body in which the working equipment is disposed, and a display control unit that displays on a display unit the virtual space image that is generated by the image generating unit, wherein the image generating unit generates the virtual space image including a virtual image corresponding to the working equipment.

### CROSS-REFERENCE TO RELATED APPLICATIONS

This application is based upon and claims the benefit of priority from Japanese Patent Application No. 2024-055987 filed on Mar. 29, 2024, the contents of which are incorporated herein by reference.

### BACKGROUND OF THE INVENTION

### Field of the Invention

The present disclosure relates to a working system.

### Description of the Related Art

In JP 6232649 B2, a virtual space display system is disclosed. In this system, a passenger in an autonomously driven vehicle wears a head mounted display. The head mounted display carries out a display with respect to an occupant of the vehicle in a virtual space image that differs from an actual environment surrounding the vehicle.

### SUMMARY OF THE INVENTION

The technique disclosed in JP 6232649 B2 simply discloses carrying out the display of the virtual space that differs from the actual environment. In recent times, it is desired to provide a more satisfactory working system.

The present invention has the object of solving the aforementioned problem.

An aspect of the present disclosure is characterized by a working system configured to carry out a work by working equipment operated remotely, the working system including an image generating unit configured to generate a virtual space image corresponding to an actual space surrounding a working movable body in which the working equipment is provided, and a display control unit configured to display on a display unit the virtual space image that is generated by the image generating unit, wherein the image generating unit generates the virtual space image including a virtual image corresponding to the working equipment.

According to the present invention, a satisfactory working system can be provided.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a diagram illustrating a working system and operations performed by working equipment;

FIG. 2 is a functional block diagram of a working movable body;

FIG. 3 is a functional block diagram of a management device;

FIG. 4 is a functional block diagram of an equipment remote operating device;

FIG. 5 is a functional block diagram of a movable body remote operating device;

FIG. 6A and FIG. 6B are diagrams illustrating examples of a virtual space image;

FIG. 7 is a diagram illustrating the virtual space image;

FIG. 8A and FIG. 8B are flowcharts showing examples of how the working movable body operates;

FIG. 9A and FIG. 9B are flowcharts showing examples of how the management device operates;

FIG. 10A and FIG. 10B are flowcharts showing examples of how the equipment remote operating device operates;

FIG. 11A and FIG. 11B are flowcharts showing examples of how the movable body remote operating device operates;

FIG. 12 is a functional block diagram of the management device;

FIG. 13 is a diagram in order to provide a description of an example of equipment operating desiring person data;

FIG. 14 is a diagram in order to provide a description of movable body operating desiring person data;

FIG. 15 is a flowchart showing an example of how the management device operates; and

FIG. 16 is a functional block diagram of the management device.

### DETAILED DESCRIPTION OF THE INVENTION

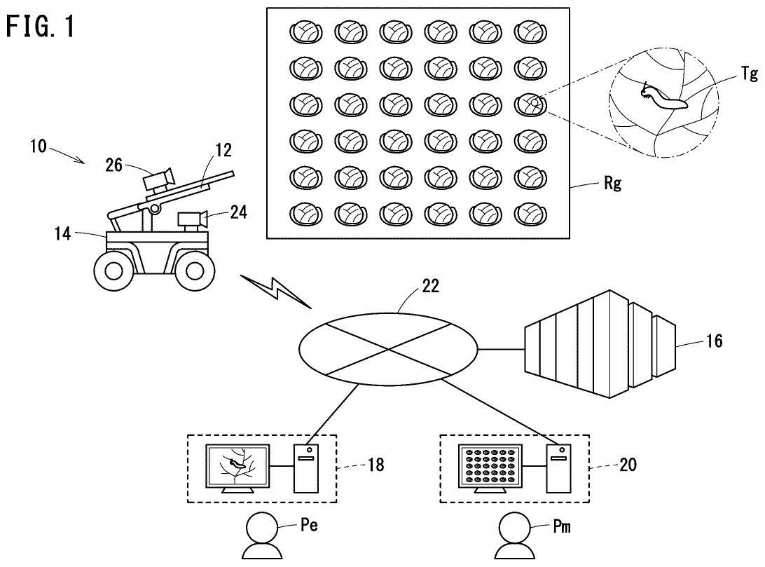

FIG. 1 is a diagram illustrating a working system 10 and a work performed by working equipment 12. In the working system 10, predetermined work is capable of being carried out by the working equipment 12 that is operated remotely. The predetermined work is the work of exterminating a working target Tg in a working region Rg. The working target Tg which serves as a target of the predetermined work, for example, is a pest, a vermin, or the like. The working region Rg, for example, is farmland, a forest, a garden, or the like. In the example shown in FIG. 1, a work is performed to exterminate, by using the working equipment 12, the working target Tg, which is a pest that is attached to a crop within the working region Rg, which is farmland.

The working equipment 12 shown in FIG. 1 is an air gun. The air gun is aimed at the working target Tg, and by a bullet being fired and hitting the working target Tg, the working target Tg can be exterminated. In the present embodiment, although the working equipment 12 is an air gun, the present invention is not necessarily limited to this feature. The working equipment 12 may be, for example, a fly swatter, a hunting gun, or the like.

The working system 10 includes a working movable body 14, a management device 16, an equipment remote operating device 18, and a movable body remote operating device 20. The working movable body 14, the management device 16, the equipment remote operation device 18, and the movable body remote operating device 20 are connected to a communication line 22 such as the Internet or the like. The working movable body 14 shown in FIG. 1 is a vehicle. In the present embodiment, although the working movable body 14 is a vehicle, the present invention is not necessarily limited to this feature. The working movable body 14, for example, may be a drone, a walking robot, or the like. The aforementioned working equipment 12, and an image capturing device 24 are provided in the working movable body 14. An image capturing device 26 is provided in the working equipment 12.

Any one of the image capturing device 24 and the image capturing device 26 can be constituted by a camera. Both of the image capturing device 24 and the image capturing device 26 acquire actual space images, which are images of the actual space surrounding the working movable body 14. The image capturing device 24 acquires an actual space image in the direction in which the working movable body 14 is moving. The actual space image acquired by the image capturing device 24, as will be discussed later, is used for remotely operating the working movable body 14.

The image capturing device 26 acquires an actual space image in the direction in which the working equipment 12 is oriented. A virtual space image corresponding to the actual space image acquired by the image capturing device 26 is used for remotely operating the working equipment 12. Moreover, it should be noted that the virtual space image is generated by the management device 16.

The equipment remote operating device 18 is operated by an equipment operating person Pe. The equipment operating person Pe, by operating the equipment remote operating device 18, remotely operates the working equipment 12. The equipment operating person Pe, while observing the virtual space image acquired from the management device 16, causes the working equipment 12 to carry out the work of exterminating the working target Tg. Even in the case that it is difficult for the working equipment 12 to be operated by a crew member of the working movable body 14, the equipment operating person Pe is capable of easily operating the working equipment 12 by means of a remote operation from anywhere in the world.

The movable body remote operating device 20 is remotely operated by a movable body operating person Pm. The movable body operating person Pm operates the working movable body 14 by means of operating the movable body remote operating device 20. The movable body operating person Pm, while observing the actual space image acquired from the working movable body 14 via the management device 16, causes the working movable body 14 to move. Even in the case that it is difficult for the working movable body 14 to be operated by a crew member, the movable body operating person Pm is capable of easily operating the working movable body 14 by means of a remote operation from anywhere in the world.

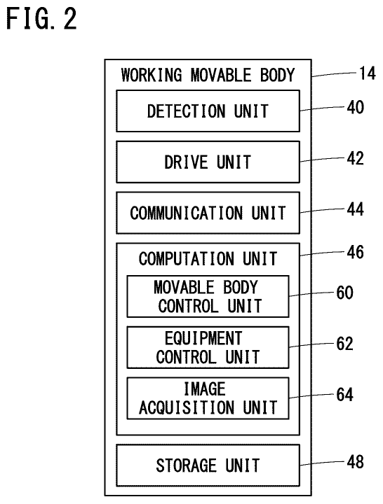

FIG. 2 is a functional block diagram of the working movable body 14. The working movable body 14 includes a detection unit 40, a drive unit 42, a communication unit 44, a computation unit 46, and a storage unit 48. The detection unit 40 detects behaviors in relation to the movement of the working movable body 14. The detection unit 40 outputs to the computation unit 46 behavior information based on a detection result of the behaviors. The detection unit 40 is constituted, for example, by an encoder, an acceleration sensor, a gyro sensor, a positioning sensor, and the like.

The drive unit 42 can be constituted, for example, by a battery, an electric motor, an internal combustion engine, a power transmission mechanism, left and right vehicle wheels, and the like. The power transmission mechanism transmits motive power from the electric motor or the internal combustion engine to the left and right vehicle wheels. The communication unit 44 can be constituted, for example, by a wireless communication module equipped with an antenna and the like. The communication unit 44 is capable of transmitting signals to the exterior of the working movable body 14. Further, the communication unit 44 is capable of receiving signals from the exterior of the working movable body 14.

The computation unit 46 includes a processor such as a CPU (Central Processing Unit) or a GPU (Graphics Processing Unit) or the like. More specifically, the computation unit 46 can be configured by a processing circuitry. At least a portion of the computation unit 46 may be realized by an integrated circuit such as an ASIC (Application Specific Integrated Circuit) or an FPGA (Field-Programmable Gate Array) or the like. At least a portion of the computation unit 46 may be realized by an electronic circuit including a discrete device.

The storage unit 48 is a computer-readable storage medium. The storage unit 48 is constituted by a non-illustrated volatile memory and a non-illustrated nonvolatile memory, which are computer readable non-transitory storage media. The volatile memory, for example, is a RAM (Random Access Memory) or the like. The volatile memory is used as a working memory of the processor.

The nonvolatile memory, for example, is a ROM (Read Only Memory), a flash memory, or the like. The nonvolatile memory stores the programs executed by the processor and other necessary data. More specifically, the working movable body 14 includes a program product of a program that is executed by the processor. At least a portion of the storage unit 48 may be provided in the above-described processor, the integrated circuit, or the like.

The computation unit 46 includes a movable body control unit 60, an equipment control unit 62, and an image acquisition unit 64. By the computation unit 46 executing a program stored in the storage unit 48, the movable body control unit 60, the equipment control unit 62, and the image acquisition unit 64 can be realized.

The movable body control unit 60 acquires behavior information output from the detection unit 40. The movable body control unit 60, based on the acquired behavior information, generates movement information in relation to movement conditions of the working movable body 14. The movement information includes information indicating the current position and the movement speed of the working movable body 14. The movable body control unit 60 transmits the generated movement information to the management device 16 via the communication unit 44 and the communication line 22.

The movable body control unit 60 acquires from the management device 16 a movable body operation signal corresponding to an operation of the working movable body 14 carried out by the movable body operating person Pm. The movable body control unit 60, in accordance with the acquired movable body operation signal, controls how the working movable body 14 operates in relation to the movement thereof. The equipment control unit 62 acquires from the management device 16 an equipment operation signal corresponding to an operation of the working equipment 12 carried out by the equipment operating person Pe. The equipment control unit 62, in response to the acquired equipment operation signal, controls the working equipment 12, and thereby causes the working equipment 12 to carry out the predetermined work.

The image acquisition unit 64 acquires the actual space image from the image capturing device 24. The image acquisition unit 64 acquires the actual space image from the image capturing device 26. The image acquisition unit 64 transmits, to the management device 16 via the communication unit 44 and the communication line 22, an image signal of the actual space images acquired respectively from the image capturing device 24 and the image capturing device 26.

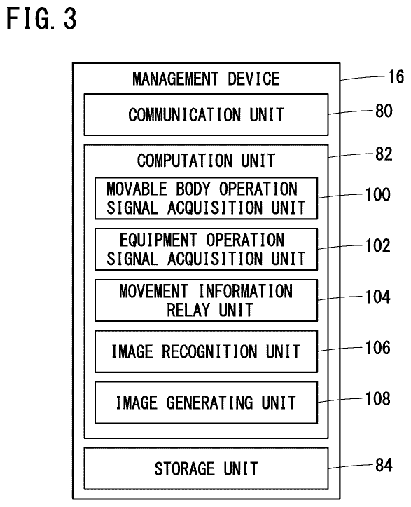

FIG. 3 is a functional block diagram of the management device 16. A communication unit 80 can be constituted, for example, by a communication module equipped with a connection interface of a communication cable. The communication unit 80 is capable of transmitting signals to the exterior of the management device 16. Further, the communication unit 80 is capable of receiving signals from the exterior of the management device 16.

A computation unit 82 may be constituted by a processor such as a CPU or a GPU or the like. More specifically, the computation unit 82 can be constituted by a processing circuit. At least a portion of the computation unit 82 may be realized by an integrated circuit such as an ASIC or an FPGA or the like. At least a portion of the computation unit 82 may be realized by an electronic circuit including a discrete device.

A storage unit 84 is a computer-readable storage medium. The storage unit 84 is constituted by a non-illustrated volatile memory and a non-illustrated nonvolatile memory. The volatile memory, for example, is a RAM or the like. The volatile memory is used as a working memory of the processor. The nonvolatile memory, for example, is a ROM, a flash memory, or the like. The nonvolatile memory stores the programs executed by the processor, image data, and the like. More specifically, the management device 16 includes a program product of a program that is executed by the processor. At least a portion of the storage unit 84 may be provided in the above-described processor, the integrated circuit, or the like.

The computation unit 82 includes a movable body operation signal acquisition unit 100, an equipment operation signal acquisition unit 102, a movement information relay unit 104, an image recognition unit 106, and an image generating unit 108. By the computation unit 82 executing a program stored in the storage unit 84, the movable body operation signal acquisition unit 100, the equipment operation signal acquisition unit 102, the image recognition unit 106, and the image generating unit 108 can be realized.

The movable body operation signal acquisition unit 100 acquires the movable body operation signal from the movable body remote operating device 20 via the communication line 22 and the communication unit 80. The movable body operation signal acquisition unit 100 transmits the acquired movable body operation signal, via the communication unit 80 and the communication line 22, to the working movable body 14. The equipment operation signal acquisition unit 102 acquires the equipment operation signal from the equipment remote operating device 18 via the communication line 22 and the communication unit 80. The equipment operation signal acquisition unit 102 transmits the acquired equipment operation signal, via the communication unit 80 and the communication line 22, to the working movable body 14.

The movement information relay unit 104 acquires from the working movable body 14, via the communication line 22 and the communication unit 80, the movement information generated by the working movable body 14. The movement information relay unit 104 transmits the acquired movement information, via the communication unit 80 and the communication line 22, to the movable body remote operating device 20.

The image recognition unit 106 acquires, from the working movable body 14 via the communication line 22 and the communication unit 80, an image signal of the actual space image acquired by the image capturing device 24, and an image signal of the actual space image acquired by the image capturing device 26. The image recognition unit 106 transmits the image signal of the actual space image acquired by the image capturing device 24, via the communication unit 80 and the communication line 22, to the movable body remote operating device 20. The image recognition unit 106 recognizes a portion corresponding to the working target Tg within the actual space image acquired by the image capturing device 26.

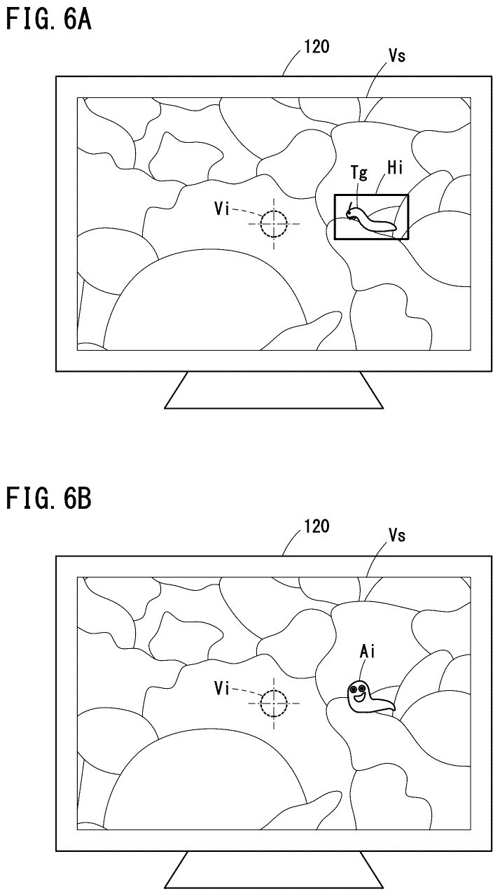

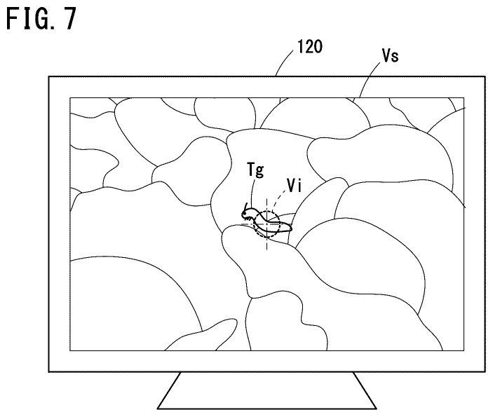

The image generating unit 108 carries out image processing on the portion recognized by the image recognition unit 106. Such image processing, for example, is image processing that emphasizes the working target Tg. Such image processing may be image processing in which an image corresponding to the working target Tg is superimposed on the working target Tg. A specific example will be discussed later using FIG. 6A, FIG. 6B, and FIG. 7. In accordance with this feature, even in the case that the working target Tg is difficult to identify with the naked eye, the equipment operating person Pe can easily recognize the working target Tg.

The image generating unit 108 generates the virtual space image corresponding to the actual space image captured by the image capturing device 26. Such a virtual space image is an image that includes a virtual image corresponding to the working equipment 12. The virtual image is determined using image data that is stored in the storage unit 84. In the case that the working equipment 12 is an air gun, for example, an image simulating a rifle target scope is used as the virtual image. In the case that the working equipment 12 is a flyswatter, for example, an image resembling a large hand is used as the virtual image. In accordance with this feature, the equipment operating person Pe can enjoy even a mundane work as if playing a game. Accordingly, a satisfactory working system 10 can be provided.

The image generating unit 108 transmits an image signal of the generated virtual space image, via the communication unit 80 and the communication line 22, to the equipment remote operating device 18.

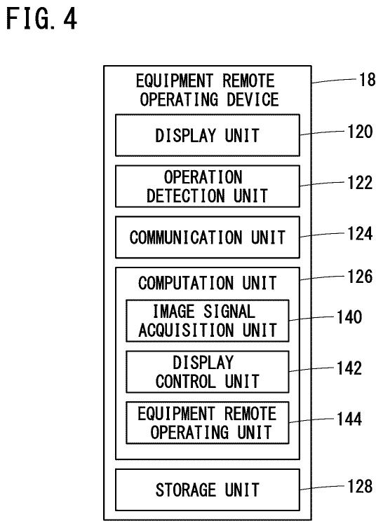

FIG. 4 is a functional block diagram of the equipment remote operating device 18. The equipment remote operating device 18 includes a display unit 120, an operation detection unit 122, a communication unit 124, a computation unit 126, and a storage unit 128.

The display unit 120 displays the virtual space image in accordance with the image signal transmitted from the management device 16. The display unit 120, for example, is a display (a monitor) of a computer such as a PC (Personal Computer) or a smart phone or the like. The display unit 120 may be a heads-up display. The display unit 120 may be a head-mounted display such as AR (Augmented Reality) goggles or the like. Moreover, it should be noted that the display unit 120 is not necessarily limited to these types of displays.

The operation detection unit 122 can be constituted, for example, by operating elements (levers, buttons, or the like) that can be operated by the equipment operating person Pe, and sensors that detect and output operations (an amount of operation, a direction of operation, or the like) of the operating elements. The operation detection unit 122 outputs to the computation unit 126 equipment operation signals corresponding to the operations of the operating elements.

The communication unit 124 can be constituted, for example, by a communication module equipped with a connection interface of a communication cable. The communication unit 124 is capable of transmitting signals to the exterior of the equipment remote operating device 18. Further, the communication unit 124 is capable of receiving signals from the exterior of the equipment remote operating device 18.

The computation unit 126 may be constituted by a processor such as a CPU or a GPU or the like. More specifically, the computation unit 126 can be constituted by a processing circuitry. At least a portion of the computation unit 126 may be realized by an integrated circuit such as an ASIC or an FPGA or the like. At least a portion of the computation unit 126 may be realized by an electronic circuit including a discrete device.

The storage unit 128 is a computer-readable storage medium. The storage unit 128 is constituted by a non-illustrated volatile memory and a non-illustrated nonvolatile memory. The volatile memory, for example, is a RAM or the like. The volatile memory is used as a working memory of the processor. The nonvolatile memory, for example, is a ROM, a flash memory, or the like. The nonvolatile memory stores the programs executed by the processor and other necessary data. More specifically, the equipment remote operating device 18 includes a program product of a program that is executed by the processor. At least a portion of the storage unit 128 may be provided in the above-described processor, the integrated circuit, or the like.

The computation unit 126 includes an image signal acquisition unit 140, a display control unit 142, and an equipment remote operating unit 144. By the computation unit 126 executing a program stored in the storage unit 128, the image signal acquisition unit 140, the display control unit 142, and the equipment remote operating unit 144 can be realized.

The image signal acquisition unit 140 acquires, from the management device 16 via the communication line 22 and the communication unit 124, an image signal of the virtual space image generated by the management device 16. The display control unit 142 causes the display unit 120 to display the virtual space image in accordance with the image signal acquired by the image signal acquisition unit 140. The equipment remote operating unit 144 acquires the equipment operation signal output by the operation detection unit 122, and transmits the equipment operation signal to the management device 16 via the communication unit 124 and the communication line 22.

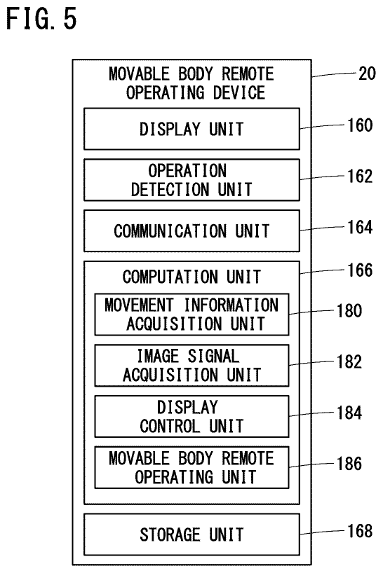

FIG. 5 is a functional block diagram of a movable body remote operating device 20. The movable body remote operating device 20 includes a display unit 160, an operation detection unit 162, a communication unit 164, a computation unit 166, and a storage unit 168. The display unit 160 displays the actual space image in accordance with the image signal transmitted from the management device 16. The actual space image is an image captured by the image capturing device 24, and corresponds to the actual space surrounding the working movable body 14.

The display unit 160, for example, is a display (a monitor) of a computer such as a PC (Personal Computer) or a smart phone or the like. The display unit 160 may be a heads-up display. The display unit 160 may be a head-mounted display such as AR (Augmented Reality) goggles or the like. Moreover, it should be noted that the display unit 160 is not necessarily limited to these types of displays.

The operation detection unit 162 can be constituted, for example, by operating elements (levers, buttons, or the like) that can be operated by the movable body operating person Pm, and sensors that detect and output operations (an amount of operation, a direction of operation, or the like) of the operating elements. The operation detection unit 162 outputs to the computation unit 166 equipment operation signals corresponding to the operations of the operating elements.

The communication unit 164 can be constituted, for example, by a communication module equipped with a connection interface of a communication cable. The communication unit 164 is capable of transmitting signals to the exterior of the movable body remote operating device 20. Further, the communication unit 164 is capable of receiving signals from the exterior of the movable body remote operating device 20.

The computation unit 166 may be constituted by a processor such as a CPU or a GPU or the like. More specifically, the computation unit 166 can be constituted by a processing circuit. At least a portion of the computation unit 166 may be realized by an integrated circuit such as an ASIC or an FPGA or the like. At least a portion of the computation unit 166 may be realized by an electronic circuit including a discrete device.

The storage unit 168 is a computer-readable storage medium. The storage unit 168 is constituted by a non-illustrated volatile memory and a non-illustrated nonvolatile memory. The volatile memory, for example, is a RAM or the like. The volatile memory is used as a working memory of the processor. The nonvolatile memory, for example, is a ROM, a flash memory, or the like. The nonvolatile memory stores the programs executed by the processor and other necessary data. More specifically, the movable body remote operating device 20 includes a program product of a program that is executed by the processor. At least a portion of the storage unit 168 may be provided in the above-described processor, the integrated circuit, or the like.

The computation unit 166 includes a movement information acquisition unit 180, an image signal acquisition unit 182, a display control unit 184, and a movable body remote operating unit 186. By the computation unit 166 executing a program stored in the storage unit 168, the movement information acquisition unit 180, the image signal acquisition unit 182, the display control unit 184, and the movable body remote operating unit 186 can be realized.

The movement information acquisition unit 180 acquires, from the management device 16 via the communication line 22 and the communication unit 164, the movement information relayed by the management device 16. The display control unit 184 may cause the display unit 160 to display information indicating the current position and the movement speed of the working movable body 14, which is included in the movement information acquired by the movement information acquisition unit 180. In such a case, the movable body operating person Pm can operate the operating elements, while taking into consideration the information of the current position and the movement speed that is displayed on the display unit 160.

The image signal acquisition unit 182 acquires, from the management device 16 via the communication line 22 and the communication unit 164, the actual space image acquired by the image capturing device 24. The display control unit 184 causes the display unit 160 to display the actual space image in accordance with the image signal acquired by the image signal acquisition unit 182. The movable body remote operating unit 186 acquires the movable body operation signal output by the operation detection unit 162, and transmits the movable body operation signal to the management device 16 via the communication unit 164 and the communication line 22.

FIG. 6A and FIG. 6B are diagrams illustrating examples of a virtual space image Vs. In the example shown in FIG. 6A and FIG. 6B, the virtual space image Vs is displayed on the display unit 120 of the equipment remote operating device 18. The virtual space image Vs includes a virtual image Vi simulating a rifle target scope. The virtual image Vi does not overlap with the image of the working target Tg. More specifically, the working equipment 12 is not oriented toward the working target Tg.

Image processing is implemented, by the image generating unit 108 of the management device 16, on a portion corresponding to the working target Tg within the virtual space image Vs. In the example shown in FIG. 6A, the image processing that is implemented on the virtual space image Vs is image processing that emphasizes the working target Tg by means of an image Hi, which is a bold frame graphic that surrounds the image of the working target Tg. The image of the working target Tg may also be enhanced by being enlarged. In the example shown in FIG. 6B, the image processing implemented on the virtual space image Vs is image processing in which an image Ai of a monster is superimposed on the working target Tg as an image corresponding to the working target Tg. By means of such image processing, the equipment operating person Pe is capable of easily recognizing the working target Tg.

FIG. 7 is a diagram illustrating the virtual space image Vs. By the equipment operating person Pe remotely operating the working equipment 12 and changing the orientation of the working equipment 12, in the example shown in FIG. 7, the virtual image Vi overlaps with the image of the working target Tg. At this time, the equipment operating person Pe, by remotely operating the working equipment 12 and causing the working equipment to act on the working target Tg, is capable of carrying out the work of exterminating the working target Tg. In the case that the working equipment 12 is an air gun, the equipment operating person Pe, by causing a bullet to be fired from the air gun and by the bullet being made to hit the working target Tg, is capable of exterminating the working target Tg. In this manner, the equipment operating person Pe is capable of easily carrying out the work.

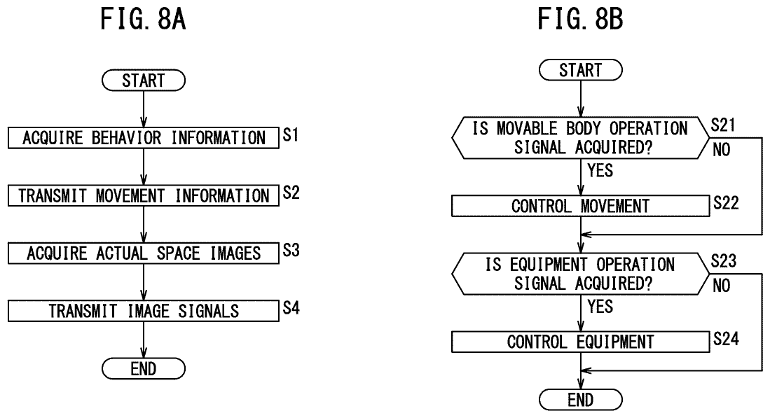

FIG. 8A and FIG. 8B are flowcharts showing examples of how the working movable body 14 operates. FIG. 8A shows a processing sequence when the working movable body 14 transmits to the management device 16 the movement information and the image signal. This processing sequence is carried out by the computation unit 46 of the working movable body 14 executing the program that is stored in the storage unit 48. The present processing sequence is repeatedly carried out during a period in which the working movable body 14 is being remotely operated.

When the present processing sequence is started, in step S1, the movable body control unit 60 acquires the behavior information that is output from the detection unit 40. In step S2, the movable body control unit 60 generates movement information based on the behavior information acquired in step S1, and transmits the generated movement information to the management device 16. In step S3, the image acquisition unit 64 acquires the actual space images from the image capturing device 24 and the image capturing device 26, respectively. In step S4, the image acquisition unit 64 transmits to the management device 16 the image signals of the actual space images acquired in step S3. When the process of step S4 is completed, the present processing sequence comes to an end.

FIG. 8B shows a processing sequence for controlling the movement of the working movable body 14 and the working equipment 12. This processing sequence is carried out by the computation unit 46 of the working movable body 14 executing the program that is stored in the storage unit 48. The present processing sequence is repeatedly carried out during a period in which the working movable body 14 is being remotely operated.

When the present processing sequence is started, in step S21, the movable body control unit 60 determines whether or not the movable body operation signal has been acquired from the management device 16. In the case that the result in step S21 has become YES, the processing sequence proceeds to step S22. In the case that the result in step S21 has become NO, the processing sequence proceeds to step S23. In step S22, the movable body control unit 60, in accordance with the acquired movable body operation signal, controls how the working movable body 14 operates in relation to the movement thereof.

In step S23, the equipment control unit 62 determines whether or not the equipment operation signal has been acquired from the management device 16. In the case that the result in step S23 has become YES, the processing sequence proceeds to step S24. In the case that the result in step S23 has become NO, the present processing sequence comes to an end. In step S24, the equipment control unit 62 controls the working equipment 12 in accordance with the acquired equipment operation signal. When the process of step S24 is completed, the present processing sequence comes to an end.

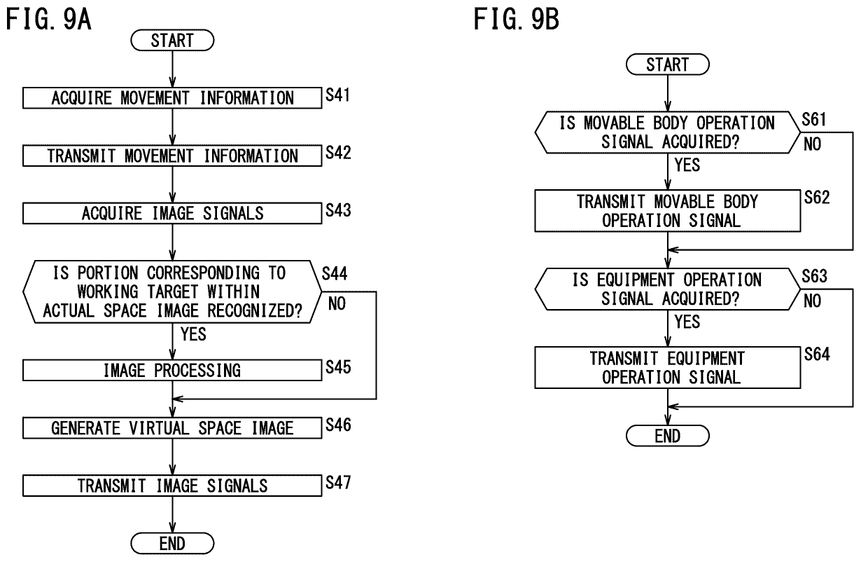

FIG. 9A and FIG. 9B are flowcharts showing examples of how the management device 16 operates. FIG. 9A shows a processing sequence when the management device 16 transmits the movement information and the image signal to the equipment remote operating device 18 and the movable body remote operating device 20. This processing sequence is carried out by the computation unit 82 of the management device 16 executing the program that is stored in the storage unit 84. The present processing sequence is repeatedly carried out during a period in which the working movable body 14 is being remotely operated.

When the present processing sequence is started, in step S41, the movement information relay unit 104 acquires the movement information from the working movable body 14. In step S42, the movement information relay unit 104 transmits the movement information acquired in step S41 to the movable body remote operating device 20. In step S43, the image recognition unit 106 acquires from the working movable body 14 an image signal of the actual space image acquired by the image capturing device 24, and an image signal of the actual space image acquired by the image capturing device 26.

In step S44, the image recognition unit 106 determines whether or not a portion corresponding to the working target Tg within the actual space image acquired by the image capturing device 26 is recognized. In the case that the result in step S44 has become YES, the processing sequence proceeds to step S45. In the case that the result in step S44 has become NO, the processing sequence proceeds to step S46. In step S45, the image generating unit 108 carries out image processing on the portion recognized by the image recognition unit 106.

In step S46, the image generating unit 108 determines the virtual image Vi corresponding to the working equipment 12 using the image data that is stored in the storage unit 84.

The image generating unit 108 superimposes the determined virtual image Vi on the image that was obtained by implementing the image processing on the actual space image in step S45. In this manner, the virtual space image Vs including the virtual image Vi, which corresponds to the actual space surrounding the working movable body 14 in which the working equipment 12 is provided, is generated by the image generating unit 108.

In step S47, the image generating unit 108 transmits to the equipment remote operating device 18 an image signal of the virtual space image Vs that was generated in step S46. Further, the image recognition unit 106 transmits to the movable body remote operating device 20 an image signal of the actual space image that was acquired in step S43 by the image capturing device 24. When the process of step S47 is completed, the present processing sequence comes to an end.

FIG. 9B shows a processing sequence of the movable body operation signal and the equipment operation signal by the management device 16. This processing sequence is carried out by the computation unit 82 of the management device 16 executing the program that is stored in the storage unit 84. The present processing sequence is repeatedly carried out during a period in which the working movable body 14 is being remotely operated.

When the present processing sequence is started, in step S61, the movable body operation signal acquisition unit 100 determines whether or not the movable body operation signal has been acquired from the movable body remote operating device 20. In the case that the result in step S61 has become YES, the processing sequence proceeds to step S62. In the case that the result in step S61 has become NO, the processing sequence proceeds to step S63. In step S62, the movable body operation signal acquisition unit 100 transmits the acquired mobile movable body operation signal to the working movable body 14.

In step S63, the equipment operation signal acquisition unit 102 determines whether or not the equipment operation signal has been acquired from the equipment remote operating device 18. In the case that the result in step S63 has become YES, the processing sequence proceeds to step S64. In the case that the result in step S63 has become NO, the present processing sequence comes to an end. In step S64, the equipment operation signal acquisition unit 102 transmits the acquired equipment operation signal to the working movable body 14. When the process of step S64 is completed, the present processing sequence comes to an end.

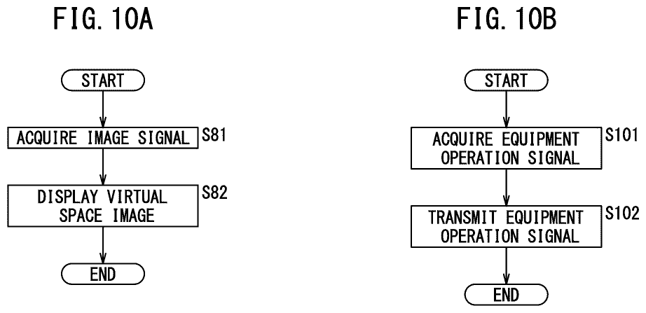

FIG. 10A and FIG. 10B are flowcharts showing examples of how the equipment remote operating device 18 operates. FIG. 10A shows a processing sequence when the equipment remote operating device 18 has acquired an image signal from the management device 16. This processing sequence is carried out by the computation unit 126 of the equipment remote operating device 18 executing the program that is stored in the storage unit 128. The present processing sequence is repeatedly carried out during a period in which the working movable body 14 is being remotely operated.

When the present processing sequence is started, in step S81, the image signal acquisition unit 140 acquires from the management device 16 an image signal of the virtual space image Vs that was generated by the management device 16. In step S82, the display control unit 142 causes the display unit 120 to display the virtual space image Vs in accordance with the image signal acquired in step S81. When the process of step S82 is completed, the present processing sequence comes to an end.

FIG. 10B shows a processing sequence when the equipment remote operating device 18 transmits the equipment operation signal in order to remotely operate the working equipment 12. This processing sequence is carried out by the computation unit 126 of the equipment remote operating device 18 executing the program that is stored in the storage unit 128. The present processing sequence is repeatedly carried out during a period in which the working movable body 14 is being remotely operated.

When the present processing sequence is started, in step S101, the equipment remote operating unit 144 acquires the equipment operation signal that is output in accordance with the operation of the operating elements by the equipment operating person Pe. In step S102, the equipment remote operating unit 144 transmits to the management device 16 the equipment operation signal that was acquired in step S101. When the process of step S102 is completed, the present processing sequence comes to an end.

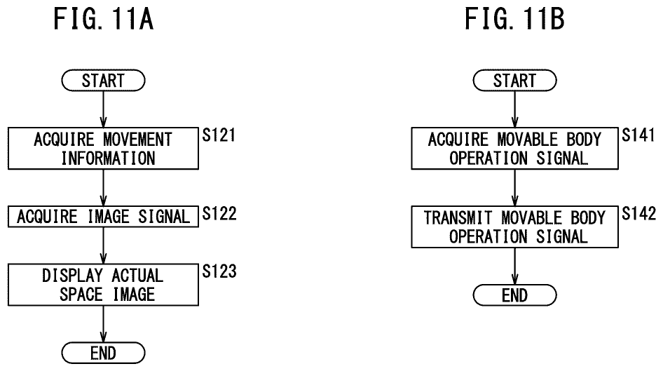

FIG. 11A and FIG. 11B are flowcharts showing examples of how the movable body remote operating device 20 operates. FIG. 11A shows a processing sequence when the movable body remote operating device 20 has acquired an image signal from the management device 16. This processing sequence is carried out by the computation unit 166 of the movable body remote operating device 20 executing the program that is stored in the storage unit 168. The present processing sequence is repeatedly carried out during a period in which the working movable body 14 is being remotely operated.

When the present processing sequence is started, in step S121, the movement information acquisition unit 180 acquires from the management device 16 the movement information that was generated by the working movable body 14. In step S122, the image signal acquisition unit 182 acquires from the management device 16 an image signal of the actual space image acquired by the image capturing device 24. In step S123, the display control unit 184 causes the display unit 160 to display the actual space image in accordance with the image signal acquired in step S122. When the process of step S123 is completed, the present processing sequence comes to an end.

FIG. 11B shows a processing sequence when the movable body remote operating device 20 transmits the movable body operation signal in order to remotely operate the working movable body 14. This processing sequence is carried out by the computation unit 166 of the movable body remote operating device 20 executing the program that is stored in the storage unit 168. The present processing sequence is repeatedly carried out during a period in which the working movable body 14 is being remotely operated.

When the present processing sequence is started, in step S141, the movable body remote operating unit 186 acquires the movable body operation signal in accordance with the operation of the operating elements by the movable body operating person Pm. In step S142, the movable body remote operating unit 186 transmits to the management device 16 the movable body operation signal that was acquired in step S141. When the process of step S142 is completed, the present processing sequence comes to an end.

The above-described embodiment may be modified in the manner indicated below. In the following exemplary modifications, descriptions which overlap with those of the above-described embodiment will be omitted.

### Exemplary Modification 1

In the above-described embodiment, the equipment remote operating device 18 is operated by the equipment operating person Pe. The movable body remote operating device 20 is remotely operated by the movable body operating person Pm. The equipment operating person Pe and the mobile body operating person Pm may be determined from among operating desiring persons who desire to operate, respectively, the working equipment 12 and the working movable body 14. In the present Exemplary Modification 1, the operating desiring person data for each of the working equipment 12 and the working movable body 14 is used.

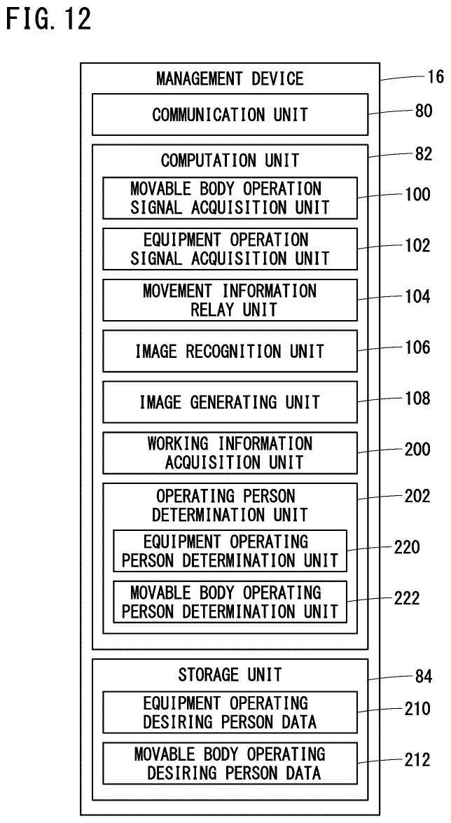

FIG. 12 is a functional block diagram of the management device 16. In FIG. 12, the same reference numerals are used for the constituent elements that are common with FIG. 3. A description concerning such constituent elements will be omitted. The computation unit 82 shown in FIG. 12 further includes a working information acquisition unit 200 and an operating person determination unit 202. By the computation unit 82 executing the program that is stored in the storage unit 84, the working information acquisition unit 200, and the operating person determination unit 202 can be realized.

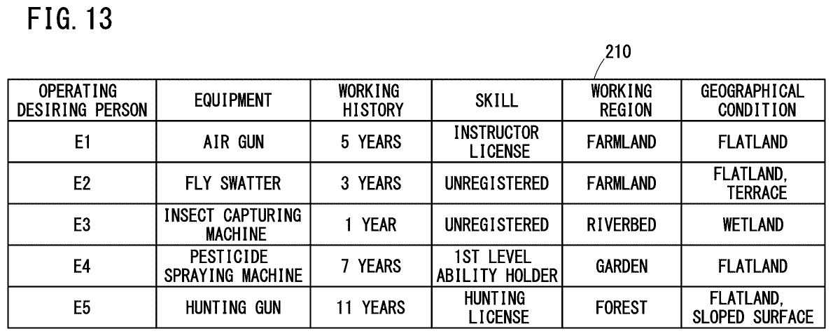

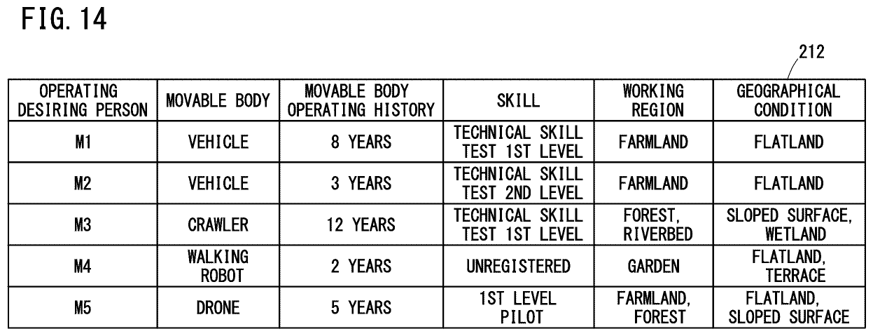

The storage unit 84 further stores in advance equipment operating desiring person data 210 and movable body operating desiring person data 212. The equipment operating desiring person data 210 is data concerning an equipment operating desiring person who desires to operate the working equipment 12. The movable body operating desiring person data 212 is data concerning a movable body operating desiring person who desires to operate the working movable body 14. A description will be given later with reference to FIG. 13 and FIG. 14, respectively, concerning examples of the equipment operating desiring person data 210 and the movable body operating desiring person data 212.

When a requesting person of a predetermined work inputs working information, which is information in relation to the predetermined work, into a non-illustrated working information input device, the working information acquisition unit 200 acquires the working information, via the communication line 22 and the communication unit 80, from the working information input device. The working information, for example, includes region information indicating that the working region Rg is agricultural land, geographic information indicating that the working region Rg is located on flat land as a geographical condition of the working region Rg, location information in relation to the position and the size of the working region Rg, schedule information indicating the working time and the working period when a predetermined work will be performed, and working target information in relation to the working target Tg.

The operating person determination unit 202 further includes an equipment operating person determination unit 220 and a movable body operating person determination unit 222. The equipment operating person determination unit 220 acquires the equipment operating desiring person data 210 from the storage unit 84. The equipment operating person determination unit 220 determines, based on the aforementioned working information and the equipment operating desiring person data 210, the equipment operating person Pe who will carry out the operation of the working equipment 12. In accordance with this feature, the operating person determination unit 202 is capable of determining an appropriate equipment operating person Pe.

The movable body operating person determination unit 222 acquires the movable body operating desiring person data 212 from the storage unit 84. The movable body operating person determination unit 222, based on the aforementioned working information and the movable body operating desiring person data 212, determines the movable body operating person Pm who will carry out the operation of the working movable body 14. In accordance with this feature, the operating person determination unit 202 is capable of determining an appropriate movable body operating person Pm.

The equipment operating desiring person data 210 includes at least one of the working history of the equipment operating desiring person, the skill of the equipment operating desiring person, or the item of information in relation to the working equipment 12 that the equipment operating desiring person is capable of operating. The equipment operating desiring person data 210 may further include at least one of the item of information in relation to the working region Rg that the equipment operating desiring person is capable of handling, or the item of information in relation to the geographical condition that the equipment operating desiring person is capable of handling.

The equipment operating desiring person data 210 may further include at least one of items of location condition information, schedule condition information, or working target condition information. A location and a size of the working region Rg that the equipment operating desiring person is capable of handling are determined by the location condition. A working time and a working period during which the equipment operating desiring person is capable of carrying out the predetermined work are determined by the schedule condition. The working target Tg (a pest, a vermin, a pest bird, or the like) that the equipment operating desiring person is capable of handling is determined by the working target condition.

FIG. 13 is a diagram in order to provide a description of an example of the equipment operating desiring person data 210. In FIG. 13, data of a plurality of equipment operating desiring persons E1, E2, . . . , E5 who desire to operate the equipment is illustrated. In the equipment operating desiring person data 210, there is recorded information concerning the working equipment 12 that each of the equipment operating desiring persons is capable of operating, such as an air gun, a fly swatter, a hunting gun, or the like. In the equipment operating desiring person data 210, there is recorded, as a working history of each of the equipment operating desiring persons, the number of years of experience of working in having used the working equipment 12.

In the equipment operating desiring person data 210, there is recorded, as skills of each of the equipment operating desiring persons, qualifications and licenses possessed by each of the equipment operating desiring persons, and passed tests and the like by each of the equipment operating desiring persons. In the equipment operating desiring person data 210, as the working regions Rg in which each of the equipment operating desiring persons has carried out experienced work, agricultural lands, gardens, forests, and the like are recorded. In the equipment operating desiring person data 210, as the geographical conditions of the working regions Rg in which each of the equipment operating desiring persons has carried out the experienced work, there are recorded flat lands, wet lands, sloped surfaces, and the like.

Moreover, in FIG. 13, the location condition information, the schedule condition information, and the working target condition information are all omitted from the illustration. In practice, the equipment operating person Pe is determined by the equipment operating person determination unit 220 upon having taken into consideration the schedule conditions and the like.

The movable body operating desiring person data 212 may further include at least one of a movable body operating history of the movable body operating desiring person, a skill of the movable body operating desiring person, or the item of information in relation to the working movable body 14 that the movable body operating desiring person is capable of handling. The movable body operating desiring person data 212 may further include at least one of the item of information in relation to the working region Rg that the movable body operating desiring person is capable of handling, or the item of information in relation to the geographical condition that the movable body operating desiring person is capable of handling.

The movable body operating desiring person data 212 may further include at least one of the items of location condition information, or schedule condition information. A location and a size of the working region Rg that the movable body operating desiring person is capable of handling are determined by the location condition. A working time and a working period during which the movable body operating desiring person is capable of handling the work are determined by the schedule condition.

FIG. 14 is a diagram in order to provide a description of the movable body operating desiring person data 212. In FIG. 14, data of a plurality of the movable body operating desiring persons M1, M2, . . . , M5 who desire to operate the movable body is illustrated. In the movable body operating desiring person data 212, there is recorded information concerning the working movable body 14 that each of the movable body operating desiring persons is capable of operating, such as a vehicle, a walking robot, a drone, or the like. In the movable body operating desiring person data 212, there is recorded, as a working history of the working movable body 14 of each of the movable body operating desiring persons, the number of years of experience in having operated the working movable body 14.

In the movable body operating desiring person data 212, there are recorded, as skills of each of the movable body operating desiring persons, qualifications and licenses possessed by each of the movable body operating desiring persons, and passed tests and the like by each of the movable body operating desiring persons. In the movable body operating desiring person data 212, as the working regions Rg in which each of the movable body operating desiring persons has operated the working movable body 14, agricultural lands, gardens, forests, and the like are recorded. In the movable body operating desiring person data 212, as the geographical conditions of the working regions Rg in which each of the movable body operating desiring persons has operated the working movable body 14, there are recorded flat lands, wet lands, sloped surfaces, and the like.

Moreover, in FIG. 14, the location condition information, and the schedule condition information are all omitted from the illustration. In practice, the movable body operating person Pm is determined by the movable body operating person determination unit 222 upon having taken into consideration the schedule conditions and the like.

Even in the case that the difficulty of the predetermined work indicated by the working information is high, based on the equipment operating desiring person data 210 and/or the movable body operating desiring person data 212, it is possible to determine an appropriate equipment operating person Pe and/or an appropriate movable body operating person Pm. For example, an operating desiring person for whom the number of years of experience in operating the equipment or in operating the movable body is long, or alternatively, an operating desiring person having experience in working or experience in operating in a working region Rg in which the geographical conditions thereof are difficult can be preferentially determined as an appropriate equipment operating person Pe and/or an appropriate movable body operating person Pm.

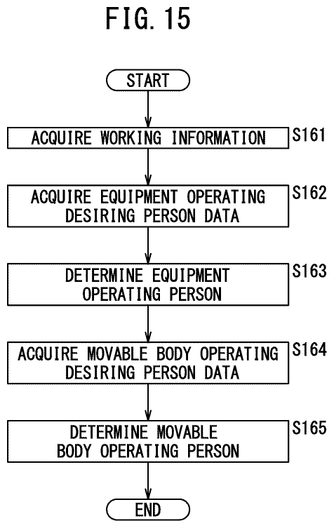

FIG. 15 is a flowchart showing an example of how the management device 16 operates. FIG. 15 shows a processing sequence when the operating person determination unit 202 determines the equipment operating person Pe and the movable body operating person Pm. This processing sequence is carried out by the computation unit 82 of the management device 16 executing the program that is stored in the storage unit 84. The present processing sequence is carried out in the case that a requesting person of a predetermined work has input the working information into the working information input device.

When the present processing sequence is started, in step S161, the equipment operating person determination unit 220 and the movable body operating person determination unit 222 acquire the working information from the working information input device. In step S162, the equipment operating person determination unit 220 acquires the equipment operating desiring person data 210 from the storage unit 84. In step S163, based on the working information acquired in step S161 and the equipment operating desiring person data 210 acquired in step S162, the equipment operating person determination unit 220 determines the equipment operating person Pe.

In step S164, the movable body operating person determination unit 222 acquires the movable body operating desiring person data 212 from the storage unit 84. In step S165, based on the working information acquired in step S161, and the movable body operating desiring person data 212 acquired in step S164, the movable body operating person determination unit 222 determines the movable body operating person Pm. When the process of step S165 is completed, the present processing sequence comes to an end.

### Exemplary Modification 2

In the aforementioned Exemplary Modification 1, the operating person determination unit 202 determines the equipment operating person Pe and the movable body operating person Pm. The equipment operating person Pe and the movable body operating person Pm that are determined are not limited to being one person each. According to the Exemplary Modification 2, a formation made up of a plurality of the equipment operating persons Pe and a plurality of the movable body operating persons Pm is determined.

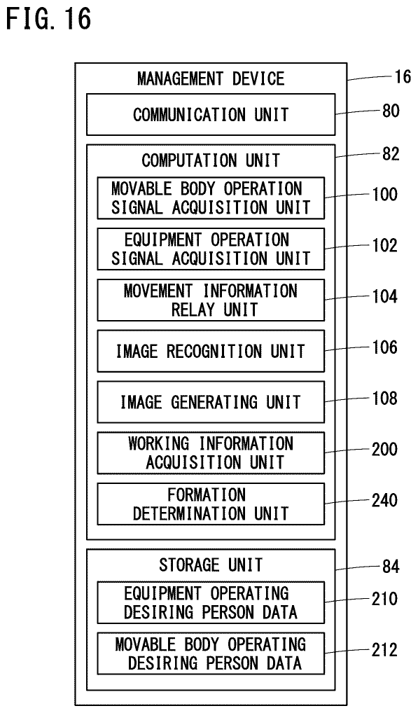

FIG. 16 is a functional block diagram of the management device 16. In FIG. 16, the same reference numerals are used for the constituent elements that are common with FIG. 3 or FIG. 12. A description concerning such constituent elements will be omitted. The computation unit 82 shown in FIG. 16 further includes a formation determination unit 240. By the computation unit 82 executing the program that is stored in the storage unit 84, the formation determination unit 240 can be realized.

The formation determination unit 240 acquires from the storage unit 84 the equipment operating desiring person data 210 and the movable body operating desiring person data 212. The formation determination unit 240 determines, in accordance with the working information acquired by the working information acquisition unit 200, a formation made up from a plurality of the equipment operating persons Pe and a plurality of the movable body operating persons Pm. The formation determination unit 240 may further determine the formation, an arrangement, and a strategy of a plurality of the working equipment 12 and a plurality of the working movable bodies 14 that are used in the formation.

For example, the formation is determined which is made up from a plurality of vehicles, each of which is equipped with an air gun, and a drone equipped with a pesticide spraying machine. The formation is determined in which the plurality of vehicles move in two columns following a leading drone. How a pesticide is sprayed from the pesticide spraying machine provided on the leading drone, and how bullets are fired at the pests from the air guns provided on the following vehicles is determined by the formation. By the pests being shot by the air gun at a timing at which the movement of the pests is suppressed by the pesticide, a strategy is determined that enhances the extermination effect of exterminating the pests.

By determining the formation, a sense of unity can be brought about among the plurality of the equipment operating persons Pe and the plurality of the movable body operating persons Pm who are members of the formation. Accordingly, the motivation of the equipment operating persons Pe and the movable body operating persons Pm with respect to the predetermined work is heightened, thereby making it possible to provide a more satisfactory working system 10.

The following supplementary notes are further disclosed in relation to the above-described embodiment and the exemplary modifications.

### Supplementary Note 1

The working system (10) configured to carry out the work by the working equipment (12) operated remotely includes the image generating unit (108) configured to generate the virtual space image (Vs) corresponding to the actual space surrounding the working movable body (14) in which the working equipment is provided, and the display control unit (142) configured to display on the display unit (120) the virtual space image that is generated by the image generating unit, wherein the image generating unit generates the virtual space image including the virtual image (Vi) corresponding to the working equipment. In accordance with such a configuration, the equipment operating person who carries out the operation of the working equipment can enjoy even a mundane work as if playing a game. Accordingly, a satisfactory working system can be provided.

### Supplementary Note 2

In the working system according to Supplementary Note 1, the image generating unit may generate the virtual space image in which image processing has been applied to a portion corresponding to the working target (Tg) that serves as a target of the work. In accordance with such a configuration, even in the case that the working target is difficult to identify with the naked eye, the equipment operating person can easily recognize the working target.

### Supplementary Note 3

In the working system according to Supplementary Note 2, the image processing may be image processing that emphasizes the working target. In accordance with such a configuration, it is possible for the equipment operating person to easily recognize the working target.

### Supplementary Note 4

In the working system according to Supplementary Note 2, the image processing may be image processing that superimposes on the working target an image (Ai) corresponding to the working target. In accordance with such a configuration, it is possible for the equipment operating person to easily recognize the working target.

### Supplementary Note 5

In the working system according to Supplementary Note 1, the working movable body may be remotely operated. In accordance with such a configuration, even in the case that it is difficult for the working movable body to be operated by a crew member, the movable body operating person who carries out the operation of the working movable body is capable of easily operating the working movable body by means of a remote operation.

### Supplementary Note 6

In the working system according to Supplementary Note 1, there may further be provided the operating person determination unit (202) configured to determine, based on the working information, which is information in relation to the work, the equipment operating desiring person data (210) in relation to the equipment operating desiring person who desires to operate the working equipment, and the movable body operating desiring person data (212) in relation to the movable body operating desiring person who desires to operate the movable body, the equipment operating person (Pe) who carries out the operation of the working equipment, and the movable body operating person (Pm) who carries out the operation of the working movable body. In accordance with such a configuration, even in the case that the difficulty of the predetermined work indicated by the working information is high, it is possible to determine an appropriate equipment operating person and an appropriate movable body operating person.

### Supplementary Note 7

In the working system according to Supplementary Note 1, there may further be provided the equipment operating person determination unit (220) configured to determine, based on the working information, which is information in relation to the work, and the equipment operating desiring person data in relation to the equipment operating desiring person who desires to operate the working equipment, an equipment operating person who carries out the operation of the working equipment, wherein the equipment operating desiring person data may include at least one of the working history of the equipment operating desiring person, the skill of the equipment operating desiring person, or the item of information in relation to the working equipment that the equipment operating desiring person is capable of operating. In accordance with such a configuration, even in the case that the difficulty of the predetermined work indicated by the working information is high, it is possible to determine an appropriate equipment operating person.

### Supplementary Note 8

In the working system according to Supplementary Note 1, there may further be provided the movable body operating person determination unit (222) configured to determine, based on the working information, which is information in relation to the work, and the movable body operating desiring person data in relation to the movable body operating desiring person who desires to operate the movable body, the movable body operating person who carries out the operation of the working movable body, wherein the movable body operating desiring person data includes at least one of the movable body operating history of the movable body operating desiring person, the skill of the movable body operating desiring person, or the item of information in relation to the working movable body that the movable body operating desiring person is capable of operating. In accordance with such a configuration, even in the case that the difficulty of the predetermined work indicated by the working information is high, it is possible to determine an appropriate movable body operating person.

### Supplementary Note 9

In the working system according to Supplementary Note 1, there may further be provided the equipment operating person determination unit configured to determine, based on the working information, which is information in relation to the work, and equipment operating desiring person data in relation to the equipment operating desiring person who desires to operate the working equipment, an equipment operating person who carries out the operation of the working equipment, wherein the equipment operating desiring person data may include at least one of the item of information in relation to the working region (Rg) that the equipment operating desiring person is capable of handling, or the item of information in relation to the geographical condition that the equipment operating desiring person is capable of handling. In accordance with such a configuration, even in the case that the difficulty of the predetermined work indicated by the working information is high, it is possible to determine an appropriate equipment operating person.

### Supplementary Note 10

In the working system according to Supplementary Note 1, there may further be provided the movable body operating person determination unit configured to determine, based on the working information, which is information in relation to the work, and the movable body operating desiring person data in relation to the movable body operating desiring person who desires to operate the movable body, the movable body operating person who carries out the operation of the working movable body, wherein the movable body operating desiring person data includes at least one of the item of information in relation to the working region that the movable body operating desiring person is capable of handling, or the item of information in relation to the geographical condition that the movable body operating desiring person is capable of handling. In accordance with such a configuration, even in the case that the difficulty of the predetermined work indicated by the working information is high, it is possible to determine an appropriate movable body operating person.

### Supplementary Note 11

In the working system according to Supplementary Note 1, there may further be provided the formation determination unit (240) configured to determine, based on the working information, which is information in relation to the work, the equipment operating desiring person data in relation to the equipment operating desiring person who desires to operate the working equipment, and the movable body operating desiring person data in relation to the movable body operating desiring person who desires to operate the movable body, the formation made up from the plurality of the equipment operating persons and the plurality of the movable body operating persons, each of the plurality of the equipment operating persons carrying out the operation of the working equipment, and each of the plurality of the movable body operating persons carrying out the operation of the working movable body. In accordance with such a configuration, the motivation of the equipment operating person and the movable body operating person with respect to the predetermined work increases. Accordingly, a more satisfactory working system can be provided.

Although the present disclosure has been described in detail, the present disclosure is not necessarily limited to each of the respective embodiments described above. These embodiments may be subjected to various additions, substitutions, modifications, partial deletions, and the like, within a range that does not depart from the essence and gist of the disclosure, or the spirit of the disclosure as derived from the contents described in the claims and their equivalents. Further, these embodiments can also be implemented together in combination. For example, in the above-described embodiments, the order of each of the operations and the order of each of the processes are merely shown as examples, and the present invention is not necessarily limited to these examples. The same applies when numerical values or mathematical expressions are used in the description of the aforementioned embodiments.

1. A working system configured to carry out a work by working equipment that is operated remotely, the working system comprising one or more processors that execute a computer-executable instruction that is stored in a memory, wherein the one or more processors execute the computer-executable instruction to cause the working system to:
generate a virtual space image corresponding to an actual space surrounding a working movable body in which the working equipment is provided; and
display on a display unit the virtual space image; and
wherein, in generation of the virtual space image, the one or more processors cause the working system to generate the virtual space image including a virtual image corresponding to the working equipment.

2. The working system according to claim 1, wherein, in the generation of the virtual space image, the one or more processors cause the working system to generate the virtual space image in which image processing has been applied to a portion corresponding to a working target that serves as a target of the work.

3. The working system according to claim 2, wherein the image processing is image processing that emphasizes the working target.

4. The working system according to claim 2, wherein the image processing is image processing that superimposes on the working target an image corresponding to the working target.

5. The working system according to claim 1, wherein the working movable body is remotely operated.

6. The working system according to claim 1, wherein, the one or more processors execute the computer-executable instruction to cause the working system to further determine, based on working information, which is information in relation to the work, equipment operating desiring person data in relation to an equipment operating desiring person who desires to operate the working equipment, and movable body operating desiring person data in relation to a movable body operating desiring person who desires to operate the movable body, an equipment operating person who carries out operation of the working equipment, and a movable body operating person who carries out operation of the working movable body.

7. The working system according to claim 1, wherein, the one or more processors execute the computer-executable instruction to cause the working system to further determine, based on working information, which is information in relation to the work, and equipment operating desiring person data in relation to an equipment operating desiring person who desires to operate the working equipment, an equipment operating person who carries out operation of the working equipment;
wherein the equipment operating desiring person data includes at least one of a working history of the equipment operating desiring person, a skill of the equipment operating desiring person, or an item of information in relation to the working equipment that the equipment operating desiring person is capable of operating.

8. The working system according to claim 1, wherein, the one or more processors execute the computer-executable instruction to cause the working system to further determine, based on working information, which is information in relation to the work, and movable body operating desiring person data in relation to a movable body operating desiring person who desires to operate the movable body, a movable body operating person who carries out operation of the working movable body;
wherein the movable body operating desiring person data includes at least one of a movable body operating history of the movable body operating desiring person, a skill of the movable body operating desiring person, or an item of information in relation to the working movable body that the movable body operating desiring person is capable of operating.

9. The working system according to claim 1, wherein, the one or more processors execute the computer-executable instruction to cause the working system to further determine, based on working information, which is information in relation to the work, and equipment operating desiring person data in relation to an equipment operating desiring person who desires to operate the working equipment, an equipment operating person who carries out operation of the working equipment;
wherein the equipment operating desiring person data includes at least one of an item of information in relation to a working region that the equipment operating desiring person is capable of handling, or an item of information in relation to a geographical condition that the equipment operating desiring person is capable of handling.

10. The working system according to claim 1, wherein the one or more processors execute the computer-executable instruction to cause the working system to further determine, based on working information, which is information in relation to the work, and movable body operating desiring person data in relation to a movable body operating desiring person who desires to operate the movable body, a movable body operating person who carries out operation of the working movable body;
wherein the movable body operating desiring person data includes at least one of an item of information in relation to a working region that the movable body operating desiring person is capable of handling, or an item of information in relation to a geographical condition that the movable body operating desiring person is capable of handling.

11. The working system according to claim 1, wherein, the one or more processors execute the computer-executable instruction to cause the working system to further determine, based on working information, which is information in relation to the work, equipment operating desiring person data in relation to an equipment operating desiring person who desires to operate the working equipment, and movable body operating desiring person data in relation to a movable body operating desiring person who desires to operate the movable body, a formation made up from a plurality of equipment operating persons and a plurality of movable body operating persons, each of the plurality of equipment operating persons carrying out operation of the working equipment, and each of the plurality of movable body operating persons carrying out operation of the working movable body.
